(19) United States
(12) Patent Application Publication
(10) Pub. No.: US 2015/0294403 A1
(43) Pub. Date: Oct. 15, 2015

(54) SYSTEMS AND METHODS FOR VEHICLE FLEET SHARING

(71) Applicant: Zipcar, Inc., Boston, MA (US)

(72) Inventors: Will Chu, Boston, MA (US); David Lambert, Boston, MA (US); Dylan Spencer, Medford, MA (US); Chris Wheeler, Cambridge, MA (US); Griffin Mahoney, Cambridge, MA (US); Russen Guggemos, Medford, MA (US); James Martineau, Somerville, MA (US); Guido Bartoloni, Boston, MA (US); Miles Hoffman, Cambridge, MA (US); Chris Chu, Boston, MA (US); Alex Moore-Niemi, Cambridge, MA (US); Lesley Mottla, Rockport, MA (US); Al Seely, Burlington, MA (US); Scott Rudberg, Newton, MA (US)

(21) Appl. No.: 14/686,219

(22) Filed: Apr. 14, 2015

Related U.S. Application Data
(60) Provisional application No. 61/979,460, filed on Apr. 14, 2014.

(51) Int. Cl. G06Q 30/06

(52) U.S. Cl. CPC G06Q 30/0645

(57) ABSTRACT

The disclosed technology relates generally to methods and systems for sharing vehicles between fleets. Vehicle sharing services typically experience the most use during the weekend. Thus, many vehicles used by vehicle sharing services sit idle during the week. Meanwhile, vehicle rental companies experience the most demand during the week and their vehicles are underutilized during the week. The disclosed technology, in certain embodiments, provides systems and methods for sharing vehicles between a vehicle sharing entity and a vehicle renting entity. This allows the entities to lower fleet costs and obtain better fleet utilization by moving vehicles between fleets when one entity anticipates a spike in demand. For example, the ability for the vehicle sharing service to utilize a rental vehicle agency's excess weekend inventory will allow them to meet its strong weekend demand without the need for purchasing and maintaining additional vehicles.

### RELATED APPLICATIONS

This application claims priority to and the benefit of U.S. Provisional Patent Application No. 61/979,460, filed Apr. 14, 2014, titled “Systems and Methods for Vehicle Fleet Sharing,” the content of which is incorporated by reference herein in its entirety.

### FIELD OF INVENTION

Described herein are methods and systems for sharing vehicles between a vehicle rental fleet and a vehicle sharing fleet such that the utilization rate for the vehicles is increased and the companies can reduce overhead costs.

### BACKGROUND

The disclosed technology relates generally to sharing vehicles between fleets. Vehicle sharing companies provide consumers with the ability to use a vehicle for a short period of time, often by the hour, in exchange for a fee. Vehicle sharing services typically see the most demand on the weekend when consumers are in need of a vehicle for a short period of time, such as running an errand. Vehicles available for use in a vehicle sharing service are often underutilized during the week while consumers are at work. Meanwhile, vehicle rental companies often provide consumers with the ability to rent vehicles for a long period of time, typically measured in days. Vehicle rental companies often see the most demand during the week when consumers are traveling and their vehicles are often underutilized on the weekend.

Thus, there is a need for systems and methods for facilitating sharing of vehicles between vehicle rental and vehicle sharing fleets such that the utilization rate for the shared vehicles is increased and the companies can reduce overhead costs.

### SUMMARY

The disclosed technology relates generally to methods and systems for sharing vehicles between fleets. The disclosed technology, in certain embodiments, provides systems and methods for sharing vehicles between a vehicle sharing entity and a vehicle renting entity. This allows the entities to lower fleet costs and obtain better fleet utilization by moving vehicles between fleets when one entity anticipates a spike in demand.

For example, the vehicle renting entity may allow some of its vehicles to be used by the vehicle sharing entity on the weekend when the vehicle sharing entity is experiencing its peak demand and the vehicle renting company's vehicles are otherwise sitting idle. Overall, the companies fleet needs are decreased because they can share vehicles. Each vehicle spends more time generating revenue rather than sitting idle, thus providing a better utilization rate of the vehicles. Moreover, the ability for the vehicle sharing service to utilize a rental vehicle agency's excess weekend inventory will allow them to meet its strong weekend demand without the need for purchasing and maintaining additional vehicles.

Fleet sharing may also enable the entities to reduce their footprint in terms of parking space for idle vehicles. For example, vehicles sharing services typically keep vehicles parked at convenient locations in cities. Sharing vehicles from the vehicle sharing service with a rental vehicle agency may reduce the number of parking spaces the vehicle service needs during the week and therefore reduce parking costs associated with the vehicle sharing service.

The disclosed technology, in one aspect, includes a method for sharing a fleet of shared assets among two or more entities. In certain embodiments, the method includes: receiving, by a processor of a computing device, from a control terminal associated with a shared asset, a request to physically access the shared asset, wherein the request includes an identifier; following receipt of the request to physically access the shared asset, determining, by the processor, that the identifier substantially matches an identifier associated with a reservation of the shared asset for a predetermined time window, wherein a time of receipt of the request is within the time window, then sending, by the processor, over a network, a signal to the control terminal granting access to the shared asset; and following determination that the identifier is valid, updating, by the processor, fleet data associated with the shared asset to change the fleet data from a first fleet associated with a first entity to a second fleet associated with a second entity.

The method, in certain embodiments, includes receiving, by the processor, from the control terminal, a request to return the shared asset; and updating, by the processor, fleet data associated with the shared asset to change the fleet data from the second fleet to the first fleet. In certain embodiments, the request to physically access the shared asset is a request to unlock the shared asset. In certain embodiments, the request to physically access the shared asset is a request to unlock a door of the shared asset. In certain embodiments, the control terminal is configured to interact with a lock associated with the shared asset to allow physical access to the shared asset based on the signal. In certain embodiments, the shared asset is a shared vehicle. In certain embodiments, first entity is a rental vehicle entity and the second entity is a vehicle sharing entity.

In certain embodiments, the method includes following determination that the identifier is valid, updating, by the processor, location data associated with the shared asset to change location data associated with the shared asset from a first location within the second fleet to a second location within the second fleet.

In certain embodiments, the first location is at least one of a service location and a staging location and the second location is a revenue generating location. In certain embodiments, the location of shared asset comprises at least one of a parking lot, parking spot, service location, and staging location. In certain embodiments, the location of shared asset comprises at least one of a region, state, city, town, metropolitan area, county, and country. In certain embodiments, the location data is used to track downtime and utilization.

In certain embodiments, the method includes tracking, by the processor, changes to the location data associated with the shared asset. In certain embodiments, the method includes tracking, by the processor, when the shared asset is moved from a service or staging location to a revenue generating location. In certain embodiments, the method includes accounting, by the processor, for at least one of utilization, downtime, parking expenses, insurance costs, maintenance costs and depreciation based at least in part on an amount of time the shared asset is assigned to the first location and the second location. In certain embodiments, the method includes tracking, by the processor, when the shared asset is deployed. In certain embodiments, the method includes tracking, by the processor, changes to the fleet data associated with the shared asset.

In certain embodiments, the network is at least one of a wireless network and a mobile data network.

In certain embodiments, the method includes identifying, by the processor, all shared assets within a specified fleet. In certain embodiments, the method includes identifying, by the processor, all shared assets at a user-specified location. In certain embodiments, the method includes accounting, by the processor, for at least one of utilization, downtime, parking expenses, insurance costs, maintenance costs and depreciation based at least in part on an amount of time the shared asset is assigned to each of the first fleet and the second fleet.

The disclosed technology, in one aspect, includes a method for sharing a fleet of shared assets among two or more entities. In certain embodiments, the method includes receiving, by a processor of a computing device, a request to move a plurality of shared assets between a first entity and a second entity by changing fleet data stored in a database and associated with each shared asset of the plurality of shared assets from a first fleet associated with the first entity to a second fleet associated with the second entity, thereby assigning each shared asset of the plurality of shared assets to the second fleet; updating, by the processor, fleet data associated with the plurality of shared assets to change the fleet data from the first fleet to the second fleet; and accounting, by the processor, for at least one of utilization, downtime, parking expenses, insurance costs, maintenance costs and depreciation based at least in part on an amount of time each asset in the plurality of shared assets is assigned to each of the first fleet and the second fleet.

In certain embodiments, the method includes receiving, by the processor, a request to dispatch the plurality of shared assets from a first location within the second fleet to a second location within the second fleet; and updating, by the processor, location data associated with each shared asset of the plurality of shared assets to change the location data from the first location (e.g., service location) within the second fleet to the second location (e.g., revenue location) within the second fleet.

In certain embodiments, updating location data associated with each asset in the plurality of shared assets to change the location data from the first location within the second fleet to the second location within the second fleet is done simultaneously. In certain embodiments, the first location is a service location and the second location is revenue location. In certain embodiments, the first location is at least one of a service location and a staging location and the second location is a revenue generating location. In certain embodiments, the location data of each asset of the plurality of shared assets comprises at least one of a parking lot, parking spot, service location, and staging location. In certain embodiments, the location data of each asset of the plurality of shared assets comprises at least one of a region, state, city, town, metropolitan area, county, and country. In certain embodiments, the location data is used to track downtime and utilization.

In certain embodiments, the method includes tracking, by the processor, when each asset in the plurality of shared assets is moved from a service or staging location to a revenue generating location.

In certain embodiments, the method includes tracking, by the processor, changes to the location data for each asset of the plurality of shared assets.

In certain embodiments, the method includes accounting, by the processor, for at least one of utilization, downtime, parking expenses, insurance costs, maintenance costs and depreciation based at least in part on an amount of time each asset in the plurality of shared assets is assigned to each of the first location and the second location.

In certain embodiments, each asset of the plurality of shared assets is a shared vehicle. In certain embodiments, first entity is an asset sharing entity and the second entity is an asset rental entity. In certain embodiments, the asset sharing entity is a vehicle sharing entity and the shared asset rental entity is a vehicle rental entity.

In certain embodiments, the method includes tracking, by the processor, changes to the fleet data for each asset of the plurality of shared assets. In certain embodiments, the method includes tracking, by the processor, when each asset of the plurality of shared assets is deployed. In certain embodiments, the method includes identifying, by the processor, all shared assets within a specified fleet. In certain embodiments, the method includes identifying, by the processor, all shared assets at a user-specified location.

The disclosed technology, in one aspect, includes a fleet sharing system for sharing a fleet of shared assets among two or more entities. In certain embodiments, the system includes a memory storing instructions thereon; and a processor for executing the instructions, wherein the instructions, when executed by the processor, cause the processor to: receive a request to move a plurality of shared assets between a first entity and a second entity by changing fleet data stored in a database and associated with the plurality of shared assets from a first fleet associated with the first entity to a second fleet associated with the second entity; update fleet data associated with the plurality of shared assets to change the fleet data from the first fleet to the second fleet; and account for at least one of utilization, downtime, parking expenses, insurance costs, maintenance costs and depreciation based at least in part on a time (e.g., amount of time) each asset in the plurality of shared assets is assigned to each of the first fleet and the second fleet.

In certain embodiments, the instructions, when executed by the processor, cause the processor to: receive a request to dispatch the plurality of shared assets from a first location within the second fleet and a second location within the selected fleet; and update location data associated with each asset in the plurality of shared assets to change the location data from the first location within the selected fleet to the second location within the selected fleet.

In certain embodiments, updating location data associated with each asset in the plurality of shared assets to change the location data from the first location within the second fleet to the second location within the second fleet is done simultaneously.

In certain embodiments, the first location is a service location and the second location is revenue location. In certain embodiments, the first location is at least one of a service location and a staging location and the second location is a revenue generating location. In certain embodiments, the location data of each asset of the plurality of shared assets comprises at least one of a parking lot, parking spot, service location, and staging location. In certain embodiments, the location data of each asset of the plurality of shared assets comprises at least one of a region, state, city, town, metropolitan area, county, and country. In certain embodiments, the location data is used to track downtime and utilization.

In certain embodiments, the instructions, when executed by the processor, cause the processor to: track when each asset in the plurality of shared assets is moved from a service or staging location to a revenue generating location.

In certain embodiments, the instructions, when executed by the processor, cause the processor to: track changes to the location data for each asset of the plurality of shared assets.

In certain embodiments, the instructions, when executed by the processor, cause the processor to: account for at least one of utilization, downtime, parking expenses, insurance costs, maintenance costs and depreciation based at least in part on an amount of time each asset in the plurality of shared assets is assigned to each of the first location and the second location.

In certain embodiments, each asset of the plurality of shared assets is a shared vehicle. In certain embodiments, first entity is an asset sharing entity and the second entity is an asset rental entity. In certain embodiments, the asset sharing entity is a vehicle sharing entity and the shared asset rental entity is a vehicle rental entity.

In certain embodiments, the instructions, when executed by the processor, cause the processor to: track changes to the fleet data for each asset of the plurality of shared assets. In certain embodiments, the instructions, when executed by the processor, cause the processor to: track when each asset of the plurality of shared assets is deployed.

In certain embodiments, the instructions, when executed by the processor, cause the processor to: identify all shared assets within a specified fleet. In certain embodiments, the instructions, when executed by the processor, cause the processor to: identify all shared assets at a user-specified location.

The disclosed technology, in one aspect, includes a fleet sharing system for sharing a fleet of shared assets among two or more entities. The system includes a memory storing instructions thereon; and a processor for executing the instructions, wherein the instructions, when executed by the processor, cause the processor to: receive, from a control terminal associated with a shared asset, a request to physically access the shared asset, wherein the request includes an identifier; following receipt of the request to physically access the shared asset, determine that the identifier substantially matches an identifier associated with a reservation of the shared asset for a predetermined time window, wherein a time of receipt of the request is within the time window, then sending, by the processor, over a network, a signal to the control terminal granting access to the shared asset; and following determination that the identifier is valid, update fleet data associated with the shared asset to change the fleet data from a first fleet associated with a first entity to a second fleet associated with a second entity.

In certain embodiments, the instructions, when executed by the processor, cause the processor to: receive from the control terminal, a request to return the shared asset; and update fleet data associated with the shared asset to change the fleet data from the second fleet to the first fleet.

In certain embodiments, the request to physically access the shared asset is a request to unlock the shared asset. In certain embodiments, the request to physically access the shared asset is a request to unlock a door of the shared asset. In certain embodiments, the control terminal is configured to interact with a lock associated with the shared asset to allow physical access to the shared asset based on the signal. In certain embodiments, the shared asset is a shared vehicle. In certain embodiments, first entity is a rental vehicle entity and the second entity is a vehicle sharing entity.

In certain embodiments, the instructions, when executed by the processor, cause the processor to: following determination that the identifier is valid, update location data associated with the shared asset to change location data associated with the shared asset from a first location within the second fleet to a second location within the second fleet.

In certain embodiments, the first location is at least one of a service location and a staging location and the second location is a revenue generating location. In certain embodiments, the location of shared asset comprises at least one of a parking lot, parking spot, service location, and staging location. In certain embodiments, the location of shared asset comprises at least one of a region, state, city, town, metropolitan area, county, and country. In certain embodiments, the location data is used to track downtime and utilization.

In certain embodiments, the instructions, when executed by the processor, cause the processor to: track changes to the location data associated with the shared asset. In certain embodiments, the instructions, when executed by the processor, cause the processor to: track when the shared asset is moved from a service or staging location to a revenue generating location. In certain embodiments, the instructions, when executed by the processor, cause the processor to: account for at least one of utilization, downtime, parking expenses, insurance costs, maintenance costs and depreciation based at least in part on an amount of time the shared asset is assigned to the first location and the second location. In certain embodiments, the instructions, when executed by the processor, cause the processor to: track when the shared asset is deployed. In certain embodiments, the instructions, when executed by the processor, cause the processor to: track changes to the fleet data associated with the shared asset. In certain embodiments, the network is at least one of a wireless network and a mobile data network.

In certain embodiments, the instructions, when executed by the processor, cause the processor to: identify all shared assets within a specified fleet. In certain embodiments, the instructions, when executed by the processor, cause the processor to: identify all shared assets at a user-specified location.

In certain embodiments, the instructions, when executed by the processor, cause the processor to: account for at least one of utilization, downtime, parking expenses, insurance costs, maintenance costs and depreciation based at least in part on an amount of time the shared asset is assigned to each of the first fleet and the second fleet.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is an illustration of an example system for managing the sharing of assets between two or more entities;

FIG. 2 is an illustration of an example method for sharing a fleet of shared assets among two or more entities;

FIG. 3 is an illustration of an example system for automatically moving a shared vehicle between two fleets upon receipt of a request to access the vehicle;

FIG. 4 is an example method for sharing a fleet of shared assets among two or more entities;

FIG. 5 is an illustration of an example system for managing the sharing of assets between two or more entities;

FIG. 6 shows a block diagram of an exemplary cloud computing environment; and

FIG. 7 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

In some implementations, the disclosed technology provides systems and methods for sharing vehicles between fleets. A vehicle sharing company and a vehicle renting company may utilize the disclosed technology to manage shared vehicles to reduce fleet costs and optimize utilization. For example, a set of vehicles owned by either a vehicle renting company or a vehicle sharing company may designed as shared assets such that they are shifted between the two companies fleets based on need. Shared vehicles may be shifted from the renting company to the sharing company on the weekend when the rental company's demand is low and the sharing company's demand peaks. The shared vehicles may be shifted back to the rental company's fleet after the weekend as the demand for the sharing company's vehicles subsides and the demand for the rental company's fleet increases. This enables the average utilization of each vehicle within the combined fleet of both companies to increase and also decreased the size of the combined fleet. Thus, among other things, the disclosed technology enables the companies to decrease expenses.

The disclosed technology, in some implementations, provides the ability to move and manage shared vehicles between two or more fleets (e.g., a first fleet associated with a first entity and a second fleet associated with a second entity). In some implementations, the disclosed technology permits accounting of various expenses associated with each shared vehicle such that one or more of the expenses can be attributed to each entity based on the amount of time each shared vehicle is assigned to each entity's fleet.

In some implementations, vehicle sharing refers to vehicles that can be driven by customers by the hour or day for a fee. Gas and insurance may be included. Vehicles used in a vehicle sharing system may be located in neighborhoods, cities, and airports. Typically, customers using vehicle sharing services request a specific vehicle (e.g., a vehicle with a specific year, make, model, and/or VIN number; e.g., a unique vehicle) to use (e.g., a customer does not select a class or pool of vehicles from which the vehicle sharing company assigns a vehicle to the individual). The shared vehicles can often be picked up by a consumer without the need to interact with a sales agent—for example, the shared vehicles may be parked at a location without a physical office for the vehicle sharing company nearby. An example of a vehicle sharing company is Zipcar, Inc. of Boston, Mass.

In contrast, a vehicle rental company, in some implementations, allows customers to rent vehicles for any period of time that is measured in days. Typically customers request a vehicle from a class of vehicles (e.g., compact, midsize, or SUV) when using a vehicle renting service. The vehicles are typically picked up at a location with a physical office for the vehicle rental company. An example of a vehicle renting company if Avis Rent A Car System, LLC of Parsippany-Troy Hills, N.J.

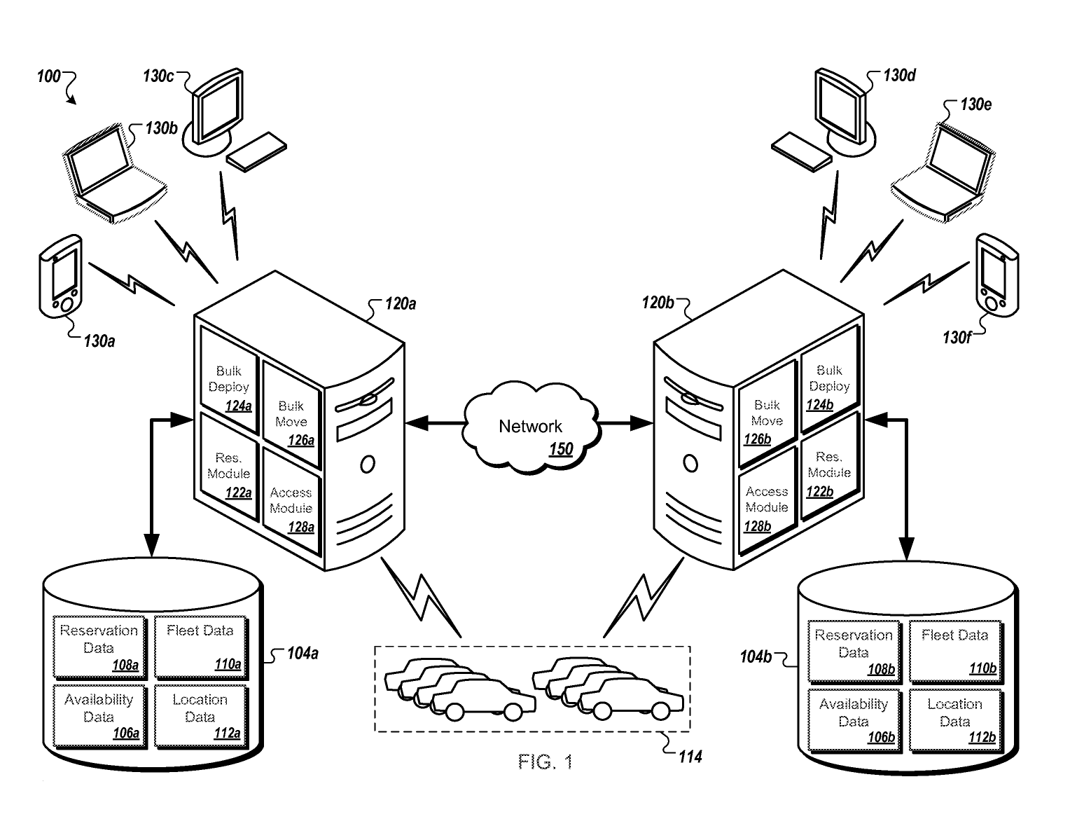

FIG. 1 is an illustration of an example system 100 for management of a shared fleet 114 between two or more entities. As shown in FIG. 1, the system may be used by two entities, each with its own computer system 120a and 120b. A similar system may be implemented with additional entities, each of whom has its own computer system. The computer system 120a of the first entity communicates with the second computer system 120b via a network 150. If additional entities participate in a fleet sharing program, their computer system would connect to system 100 via the network 150. The network may be the internet or an intranet.

Each computer system 120 is capable of receiving reservations for vehicle in its respective fleet. Reservations may be received by the first computer system 120a from, for example, a mobile phone 130a, a laptop 130b, a personal computer 130c, a tablet, or other computing devices. Similarly, reservations may be received by the first computer system 120b from, for example, a mobile phone 130f, a laptop 130e, a personal computer 130d, a tablet, or other computing devices. Each entity's computer system 120 includes a reservation module 122 that manages the reservation data 108 for each entity, respectively. Similarly, each entity has a database 104 that stores reservation data 108, fleet data 110, availability data 106, and location data 112. The reservation data 108 may include the reservation information for any given reservation in the system. The reservation information may include information regarding the individual who made the reservation, the vehicle or class of vehicle he/she reserved, identifier information for use in authenticating the reservation at a later date, preferences, and other types of reservation data.

The data in each database 104a and 104b may be mirrored such that both databases 104a and 104b contain the same location data 112, fleet data 110, reservation data 108, and availability data 106. In some implementations, only some of this data is mirrored between the databases 104a and 104b. For example, each entity may manage its own reservation data 108. In some implementations, data in each database 104a and 104b is complimentary (e.g., database 104a lists a vehicle as available for reservation at a given time with the first entity and database 104b lists the vehicle as unavailable for reservation with the second entity for the given time). In some implementations, the system 100 is implemented with a single database accessed by each entity. In other implementations, the entities each maintain a database (e.g., for reservation data 108) and also share a database (e.g., a database with fleet data 110 and location data 112)

Each database 104a and 104b contains fleet data 110a and 110b, respectively. Fleet data 110 identifies which entity a shared vehicle is currently assigned. For example, as shown in FIG. 1, fleet data 110 may indicate whether a shared vehicle is assigned to the first entity or the second entity. This may be used to account for expenses associated with the shared vehicle based on the time each vehicle is assigned to each entity. The expenses may include utilization, downtime, parking expenses, insurance costs, maintenance costs and/or depreciation. In some implementations, fleet data 110 may be mirrored between databases 104a and 104b such that both entities are aware of which fleet a shared vehicle is assigned.

Location data 112 may identify the location to which a vehicle is currently assigned. For example, these locations may include a parking lot, parking spot, service location, staging location, and/or revenue-generating location. The location data may include information regarding a region, state, city, town, metropolitan area, county, and/or country to which a vehicle is assigned.

Each database 104a and 104b may include availability data 106a and 106b, respectively. Availability data may be used to manage when vehicles in a fleet are availability for reservations. In some implementations, the availability data 106a describe when vehicles in the first entity's fleet (including shared vehicles in the shared fleet 114) are available for reservation. Similarly, in some implementations, the availability data 106b describes when vehicles in the second entity's fleet (including shared vehicles in the shared fleet 114) are available for reservation. For example, in some implementations, a shared vehicle in the shared fleet 114 may be available for reservation on a Monday with the first entity and available for a reservation on the following Tuesday with the second entity. Availability data 106a may show the vehicle as available on Monday and unavailable on Tuesday and availability data 106b may show the vehicle as unavailable on Monday and available on Tuesday. The availability data 106a and 106b may be managed by access modules 128a and 128b, respectively. The access modules 128 may work together to manage the availability data 106 and to ensure that the data in each database 104 is accurate and up to date.

In some implementations, the various modules in the computer systems 120 may push data stored in its respective database 104 when it is changed. In some implementations, the various modules in the computer systems 120 may poll for changes in the other database. In some implementations, the modules in the computer systems 120 may both push data stored in its respective database 104 when it is changed and periodically poll for changes in the other database. This hybrid system may be used to reduce potential lag time between the two databases in instances when the data is mirrored or complimentary.

The computer systems 120 may include a bulk deploy module 124 and/or a bulk move module 126. In some implementations, each of these modules is only included in one of the computer systems 120a and 120b. In some implementations, each computer system 120a and 120b has a bulk deploy module 124a and 124b, respectively. In some implementations, each computer system 120a and 120b has a bulk move module 126a and 126b, respectively.

The bulk move module 126 is an inventory management tool that allows movement multiple shared vehicles between multiple fleets simultaneously. The bulk move module 126 may be configured to manage movement shared assets between a first entity and a second entity by changing fleet data 110 associated with the shared asset from a first fleet associated with the first entity to a second fleet associated with the second entity.

In some implementations, the bulk move module 126 permits a user to view all available shared vehicles that are currently off the grid (e.g., not currently active and taking member reservations at a revenue-generating location and/or available to be moved between fleets and locations) at all service locations (e.g., a locations where vehicles are held in the system that are not at an active, revenue-generating location such as staging areas for vehicles that are ready to go to an active location or where vehicles are kept that are out for service) within each fleet. The movement of vehicles between fleets at a future date and time may be planned and/or initiated using the bulk move module 126. For example, multiple vehicles or all vehicles from one service location within a fleet may be moved to a location (e.g., a service location or active, revenue-generating location) in another fleet at one time.

The bulk move module 126 may track when (e.g., date and time, amount of time and/or specific times) vehicles are moved between fleets (e.g., a first fleet associated with a first entity and a second fleet associated with a second entity). The bulk move module 126 may use the tracking information to account for the time each vehicle is in the possession of each fleet so that utilization, downtime, maintenance costs, parking expenses, insurance, and depreciation can be attributed to the appropriate entity.

In some implementations, the bulk deploy module 124 is a deployment tool that allows movement of one or more vehicles between locations (e.g., service or staging locations and active, revenue-generating locations) simultaneously. The bulk deploy module 124 may be configured to manage dispatching of the plurality of shared assets between locations by changing location data 112 stored in the database 104 and associated with one or more shared assets from a first location within a fleet to a second location within the fleet.

For example, the bulk deploy module 124 enables the deployment of multiple or all vehicles from a service location to a revenue-generating location at one time. All available vehicles that are currently at a service location within a fleet for a selected date and time may be viewed. The deployment of these vehicles from a service location to an active location at a future date in time may be planned and/or initiated using the bulk deploy module 124. A return date and/or time to a service location may be specified such that the vehicles will automatically come off the grid when they are no longer available for reservations or renting. In some implementations, the vehicles may be tracked when they are deployed. For example, the date and time of deployment and return may be tracked. The bulk deploy module 124, in some implementations, accounts for the time each vehicle is on or off the grid so that utilization and downtime may be accurately tracked.

The computer system 120a and/or 120b may include a parking module. The parking module may be used to track and record elements of the contracts an entity has with a parking vendor. The elements may include vehicle type (e.g., regular, oversize, van, and/or electric vehicle), rates for each vehicle type, number of prepaid spaces for each vehicle type, minimum and maximum agreements for each vehicle type (if applicable), billing cycle for each vehicle type, and a start and end date of the contract for each vehicle type. In some implementations, the parking module may be used to assign specific vehicles or vehicle models to correlate with vehicle types. For example, all Ford Escapes may be designated as “oversized” for a location. When any Ford Escapes are moved to that location (e.g., using the bulk deploy module 124), fleet and location managers can see that there are X number of spaces available for oversized vehicles based on the contract and Y oversize vehicles are currently at the location.

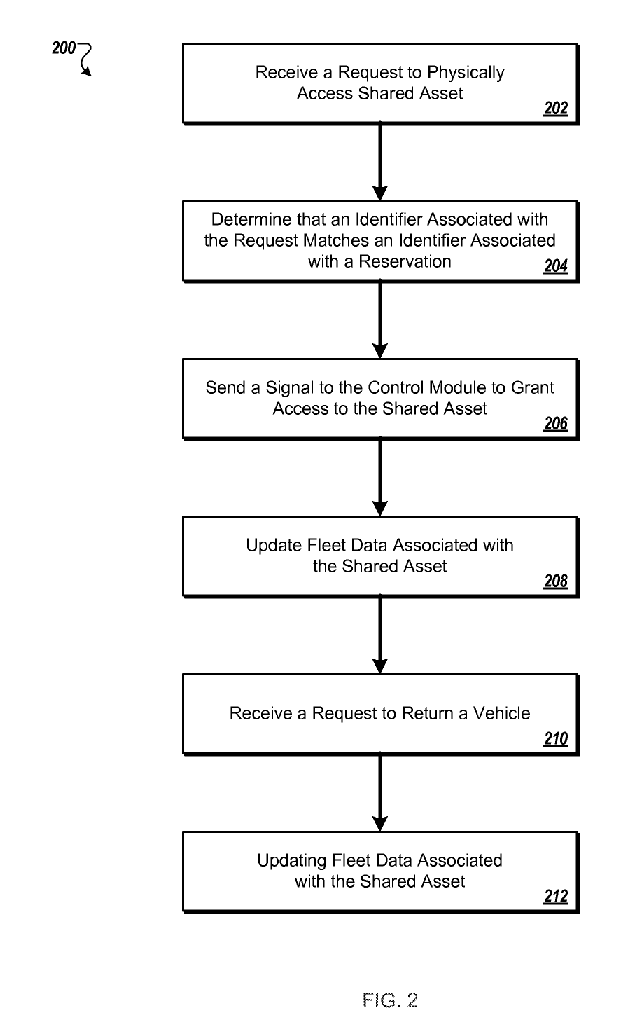

FIG. 2 is an illustration of an example method 200 for sharing a fleet of shared assets among two or more entities. The shared asset may be a shared vehicle (e.g., car, truck, and/or van). In some implementations, the method 200 includes receiving, by a processor of a computing device, from a control terminal associated with a shared asset, a request to physically access the shared asset (202). The request to physically access the shared asset may be a request to unlock the shared asset (e.g., unlock a door of the shared asset). In some implementations, the control terminal is configured to interact with a locking mechanism associated with the shared asset to allow physical access to the shared asset based on the signal.

The request may include an identifier that is associated with the user and/or the device used to initiate the request with the control terminal. The device used to initiate the request with the control terminal may be a card with a RFID/NFC chip or a mobile communication device, such as a cell phone (e.g., smart phone with NFC, Bluetooth, Wifi, or some other wireless communication technology).

Following receipt of the request to physically access the shared asset, the system determines that the identifier substantially matches an identifier associated with a reservation of the shared asset for a predetermined time window (e.g., time of receipt of the request is within the time window) (204). For example, a vehicle sharing member make a reservation for Tuesday, May 11, 2012 at 2 pm. When the user places his/her membership card in proximity to a card reader connected to the control terminal, the system may determine whether the time the request is submitted (e.g., the member places his/her card in proximity to a card reader) is within a time window associated with the date and time of the reservation. For example, the time window may be within a certain period of time (e.g., plus or minus 15 minutes) of the start of the reservation (assuming the vehicle has been returned by the previous user). If the identifier substantially matches the identifier associated with the reservation for the predetermined time window, the system may send, over a network (e.g., wireless internet connection, or mobile data connection), a signal to the control terminal granting access to the shared asset (206).

Following determination that the identifier is valid, the system may update fleet data associated with the shared asset to change the fleet data from a first fleet associated with a first entity (e.g., rental vehicle entity) to a second fleet associated with a second entity (e.g., vehicle sharing entity) (208). Moreover, the system may track movement of the shared asset between the first fleet and the second fleet. This may include tracking when the shared asset is deployed (e.g., being utilized by a customer and/or located at a revenue-generating location). The system may account for utilization, downtime, parking expenses, insurance costs, maintenance costs and/or depreciation of the shared asset based at least in part on the time the shared asset is assigned to each of the first fleet and the second fleet.

In some implementations, the method 200 includes receiving, from the control terminal, a request to return the shared asset (210) and updating fleet data associated with the shared asset to change the fleet data from a first fleet associated with a first entity to a second fleet associated with a second entity (212).

In some implementations, following determination that the identified is valid, location data (e.g., used to track downtime and utilization) associated with the shared asset changed the location data from a first location (e.g., revenue location) within a fleet to a second location (e.g., service location or staging location) within the fleet. For example, a reservation may be made such that a service technician can move the vehicle from a revenue location to a service location for maintenance. The service technician may visit the vehicle at the appropriate time and bring his/her membership card within proximity to the card reader. After confirming the technician's reservation, the location data may be updated so that the shared asset is shown as being at a service location. In some implementations, this information may be reflected on each entities' system that participates in the fleet sharing platform. In some implementations, the location data is not changed until the vehicle arrives at the new location and is checked back into the system (e.g., the technician brings the vehicle to the service location and brings his membership card within proximity of the card reader to confirm the vehicle is at the service location).

The location data may include a parking lot, parking spot, service location, staging location, a region, state, city, town, metropolitan area, county, and/or country. Movement of the shared asset between locations may be tracked by the system. For example, the system may track when the shared asset is moved from a service or staging location to a revenue generating location. Additionally, utilization, downtime, parking expenses, insurance costs, maintenance costs and depreciation may be accounted for based at least in part on the time shared asset is assigned to a location (e.g., the first location and the second location).

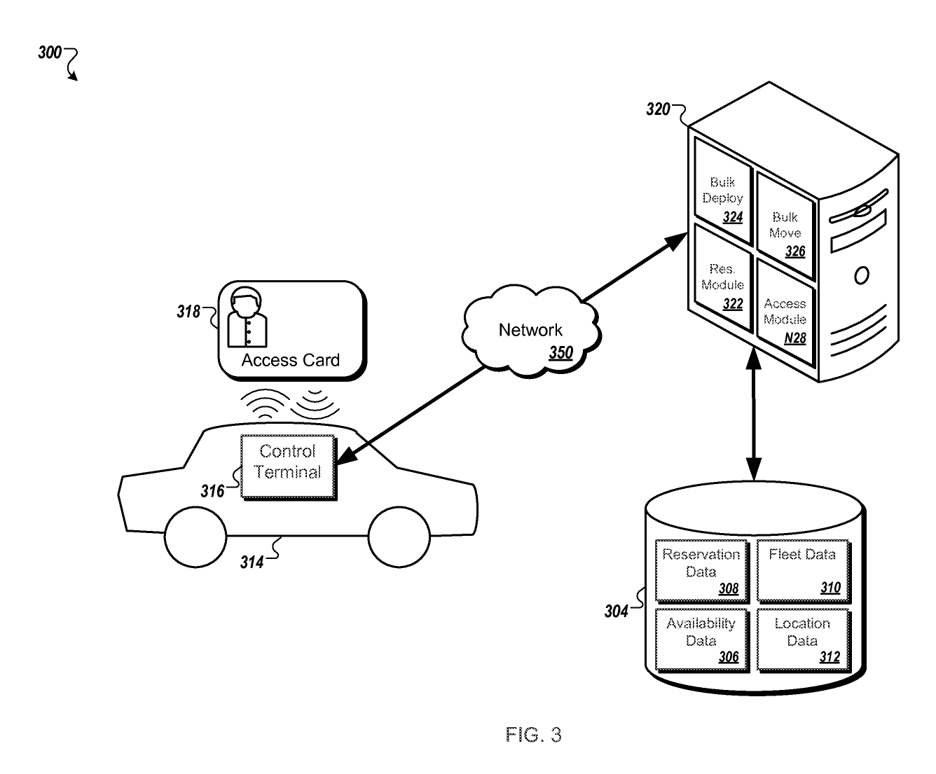

FIG. 3 is an illustration of an example system for automatically moving a shared vehicle between two fleets upon receipt of a request to access the vehicle. In some implementations, a user may request access to a shared vehicle 314 using an access card 318. The access card may be brought within the appropriate distance of a card reader in the shared vehicle 314. In some implementations, the user may use a mobile phone to transmit a request to a receiver in the shared vehicle 314 to gain access. In some implementations, a control terminal 316 in the shared vehicle 314 receives the request and processes the request to determine if the request is valid (e.g., the user has a valid reservation for the vehicle at the given time). In some implementations, the control terminal 316 relays information regarding the user to the computing system 320 via a network 350 where the information is processed to determine if the request is valid. The network 350 may be a wireless network (e.g., wifi, 3G, 4G, or other wireless data connection). The computer system 320 may include a bulk deploy module 324, bulk move module, 326, reservation module 322, and/or access module 328 as described in relation to FIG. 1. The computer system 320 may use the access module 328 to compare the request to reservation data 308 in the database 304. The database 304 may contain reservation data 308, fleet data 310, availability data 306 an location data 312 as described in relation to FIG. 1.

In some implementations, if the request is valid, a bulk move module 326 moves the shared vehicle between two fleets. The bulk move module 326 may be configured to manage movement the shared asset between a first entity and a second entity by changing fleet data 310 associated with the shared asset from a first fleet associated with the first entity to a second fleet associated with the second entity. Thus, in some implementations, the shared vehicle may automatically be moved between two fleets in response to bringing an access card 318 within a specified distance of the appropriate card reader and determining that access to the vehicle should be granted. Additionally, in some implementations, in response to determining that the request is valid, access to the vehicle may be granted to the holder of the access card 318. For example, the doors of the shared vehicle may be unlocked. The control terminal 316, in some implementations, may unlock the doors in response to a determination that the request is valid.

In some implementations, in response to a determination that the request is valid, the bulk deploy module 324 moves the shared vehicle between locations (e.g., service or staging locations and active, revenue-generating locations) automatically. The bulk deploy module 324 may be configured to manage dispatching the shared vehicle by changing location data 312 associated the shared vehicle from a first location (e.g., service location) within a fleet to a second location (e.g., revenue location) within the fleet. In some implementations, in response to a determination that the request is valid, the bulk move module will move the shared asset between fleets and the bulk deploy module will move the shared vehicle between locations. The movement between fleets and locations may happen simultaneously or one after the other.

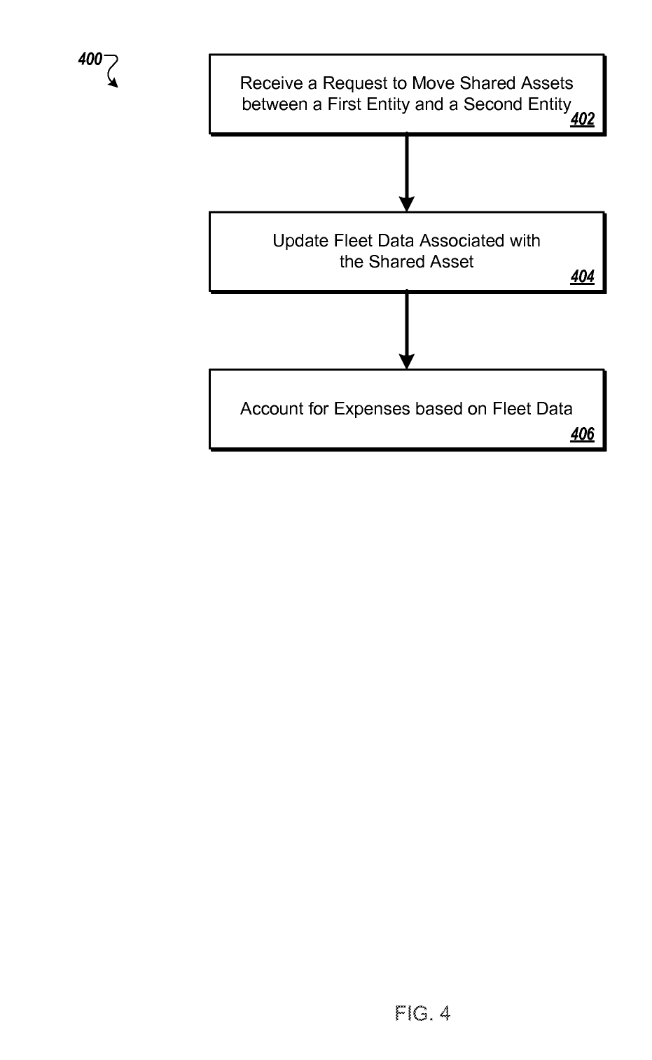

FIG. 4 is an example method 400 for sharing a fleet of shared assets among two or more entities. For example, the method may be used to move multiple vehicles between fleets such that the accounting of expenses between the fleets may be handled appropriately. In some implementations, the method 400 includes receiving a request to move a plurality of shared assets between a first entity and a second entity (402) by changing fleet data stored in a database and associated with the plurality of shared assets from a first fleet associated with the first entity to a second fleet associated with the second entity. The system may update fleet data associated with the plurality of shared assets to change the fleet data from the first fleet to the second fleet (404) in response to the request. In some implementations, the method 400 includes accounting, for at least one of utilization, downtime, parking expenses, insurance costs, maintenance costs and depreciation (406) based at least in part on a time (e.g., amount of time) each asset in the plurality of shared assets is assigned to each of the first fleet and the second fleet.

In some implementations, the method 400 includes receiving a request to dispatch the plurality of shared assets from a first location within a fleet selected from one of the first fleet and the second fleet and a second location within the selected fleet. In response to receiving the request, the system may update location data associated with each asset in the plurality of shared assets to change the location data from the first location (e.g., service location) within the selected fleet to the second location (e.g., revenue location) within the selected fleet. The first location may be a service location and/or a staging location and the second location may be a revenue generating location, or vice versa. The location data of each asset of the plurality of shared assets may be a parking lot, parking spot, service location, staging location, region, state, city, town, metropolitan area, county, and country.

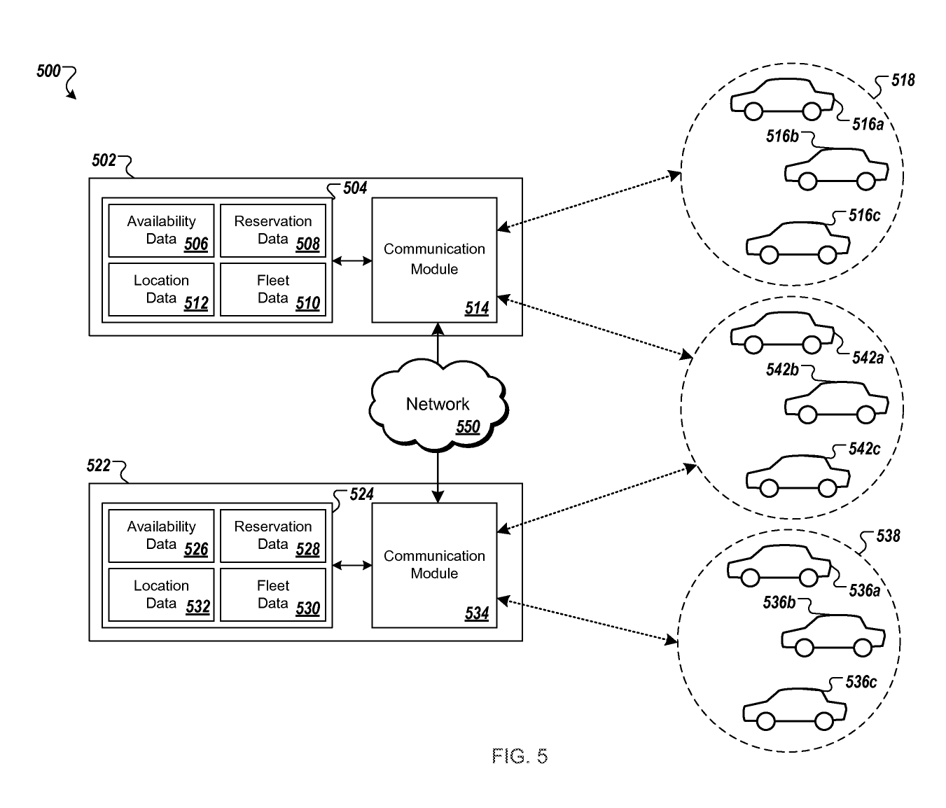

FIG. 5 is an diagram of an example system 500 for sharing a fleet between two entities. In this example, the shared assets are vehicles, however, other assets may be used in a substantially similar system, such as planes, trains, bicycles, motorcycles, and boats. In some implementations, a first entity 518 may have a fleet of vehicles 516 and a second entity 538 may have a fleet of vehicles 536. A third set of vehicles 542 includes one or more shared vehicles (e.g., shared vehicles 542a-c). The set of shared vehicles 542 may be used at different times by either the first entity 518 or the second entity 538. When a shared vehicle 542 in the set of shared vehicles 542 is used by an entity, it is considered to be part of the entity's fleet. In some implementations, each vehicle 542a-c in the set of shared vehicles 542 is always assigned to an entity, but the vehicles 542a-c may be shifted between the fleets based on the needs of the two entities. For example, the needs of a vehicle sharing service and a rental vehicle company may be complementary such that a shared vehicle 542 may be shifted between the entities and customers may reserve and use the shared vehicle 542 as a rental vehicle or with a vehicle sharing service depending on which fleet the shared vehicle 542 is assigned to at a specified date and time. In some implementations, the shared vehicles 542 are co-owned by the entities.

In some implementations, the fleet of shared vehicles 542 may be owned by one of the entities participating in the fleet sharing program (e.g., entity 518 or entity 538). For example, the first entity 518 may be a rental vehicle company. The rental vehicle entity may own a set of vehicles 516 and the shared fleet 542. However, the rental vehicle entity may only allow the shared fleet 542 to be shared with the second entity 538 (e.g., a vehicle sharing company). In some implementations, both entities contribute vehicles to the shared fleet 542.

In some implementations, the first entity's 518 fleet 516 communicates with a first vehicle management system 502 via a communication module 514. The second entity's 538 fleet 536 may communicate with a first vehicle management system 522 via a communication module 534. The communication modules 514 and 534 may communicate with one or more fleets of vehicles using a wireless data connection and/or wifi. In some implementations, the fleets of vehicles communicate with a receiver module using a wireless data connection or wifi. The receiver module may be coupled (wired or wirelessly) to the communications modules 514 and 534. Different communication systems may be used for each communication module 514 and 534.

The communication modules 514 and 534 may communicate with each other via a network 550. The network 550 may be the internet or an intranet. The communication modules 514 and 534 may communicate with each other to, among other things, ensure that each a shared vehicle 542 is not double booked. In some implementations, the communication modules 514 and 534 communicate with each other to ensure that the fleet data 510 and 530 in each database 504 and 524, respectively, is accurate. In some implementations, the vehicle management systems 502 and 522 will both push data to the other vehicle management system and poll the other vehicle management system. This reduces the amount of time data shared between the two vehicle management systems 502 and 522 differs.

Each database 504 and 524 may include availability data 506 and 526, reservation data 508 and 528, and location data 512 and 532 as described in relation to FIG. 1. In some implementations, multiple entities may share a vehicle management system, eliminating the need for duplicative systems. In some implementations, the entities may share portions of a vehicle management system while other portions remain separate and distinct. For example, each entity may maintain a unique reservation database, but the entities may share a database that stores location data and fleet data.

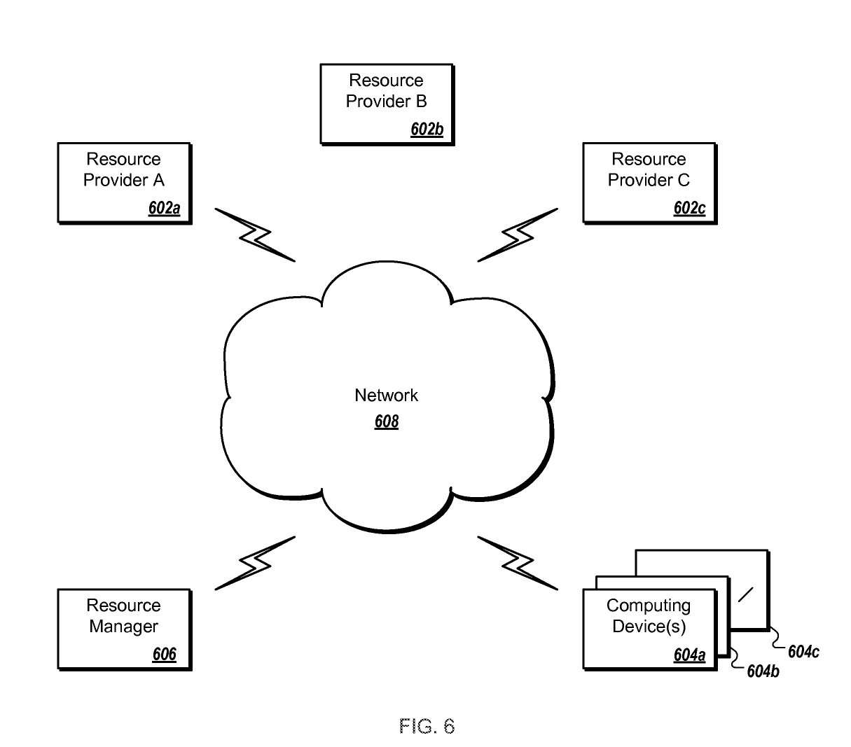

As shown in FIG. 6, an implementation of a network environment 600 for use sharing assets between fleets is shown and described. In brief overview, referring now to FIG. 6, a block diagram of an exemplary cloud computing environment 600 is shown and described. The cloud computing environment 600 may include one or more resource providers 602a, 602b, 602c (collectively, 602). Each resource provider 602 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 602 may be connected to any other resource provider 602 in the cloud computing environment 600. In some implementations, the resource providers 602 may be connected over a computer network 608. Each resource provider 602 may be connected to one or more computing device 604a, 604b, 604c (collectively, 604), over the computer network 608.

The cloud computing environment 600 may include a resource manager 606. The resource manager 606 may be connected to the resource providers 602 and the computing devices 604 over the computer network 608. In some implementations, the resource manager 606 may facilitate the provision of computing resources by one or more resource providers 602 to one or more computing devices 604. The resource manager 606 may receive a request for a computing resource from a particular computing device 604. The resource manager 606 may identify one or more resource providers 602 capable of providing the computing resource requested by the computing device 604. The resource manager 606 may select a resource provider 602 to provide the computing resource. The resource manager 606 may facilitate a connection between the resource provider 602 and a particular computing device 604. In some implementations, the resource manager 606 may establish a connection between a particular resource provider 602 and a particular computing device 604. In some implementations, the resource manager 606 may redirect a particular computing device 604 to a particular resource provider 602 with the requested computing resource.

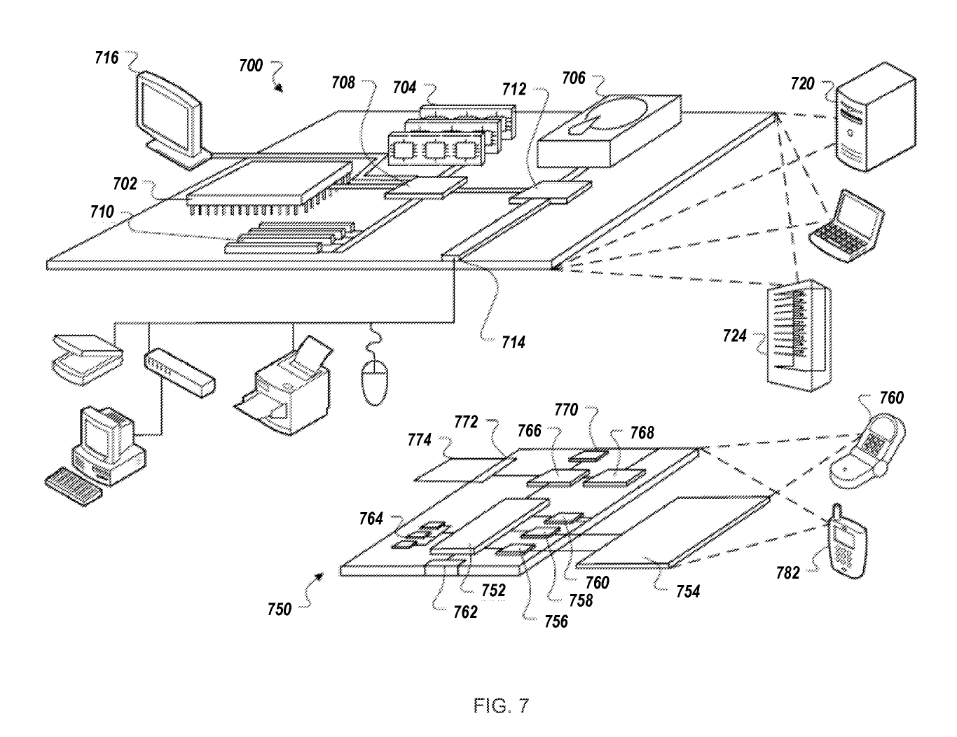

FIG. 7 shows an example of a computing device 700 and a mobile computing device 750 that can be used to implement the techniques described in this disclosure. The computing device 700 is intended to represent various forms of digital computers, such as laptops, desktops, workstations, personal digital assistants, servers, blade servers, mainframes, and other appropriate computers. The mobile computing device 750 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 700 includes a processor 702, a memory 704, a storage device 706, a high-speed interface 708 connecting to the memory 704 and multiple high-speed expansion ports 710, and a low-speed interface 712 connecting to a low-speed expansion port 714 and the storage device 706. Each of the processor 702, the memory 704, the storage device 706, the high-speed interface 708, the high-speed expansion ports 710, and the low-speed interface 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as a display 716 coupled to the high-speed interface 708. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 704 stores information within the computing device 700. In some implementations, the memory 704 is a volatile memory unit or units. In some implementations, the memory 704 is a non-volatile memory unit or units. The memory 704 may also be another form of computer-readable medium, such as a magnetic or optical disk.

The storage device 706 is capable of providing mass storage for the computing device 700. In some implementations, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 702), perform one or more methods, such as those described above. The instructions can also be stored by one or more storage devices such as computer- or machine-readable mediums (for example, the memory 704, the storage device 706, or memory on the processor 702).

The high-speed interface 708 manages bandwidth-intensive operations for the computing device 700, while the low-speed interface 712 manages lower bandwidth-intensive operations. Such allocation of functions is an example only. In some implementations, the high-speed interface 708 is coupled to the memory 704, the display 716 (e.g., through a graphics processor or accelerator), and to the high-speed expansion ports 710, which may accept various expansion cards (not shown). In the implementation, the low-speed interface 712 is coupled to the storage device 706 and the low-speed expansion port 714. The low-speed expansion port 714, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. In addition, it may be implemented in a personal computer such as a laptop computer 722. It may also be implemented as part of a rack server system 724. Alternatively, components from the computing device 700 may be combined with other components in a mobile device (not shown), such as a mobile computing device 750. Each of such devices may contain one or more of the computing device 700 and the mobile computing device 750, and an entire system may be made up of multiple computing devices communicating with each other.

The mobile computing device 750 includes a processor 752, a memory 764, an input/output device such as a display 754, a communication interface 766, and a transceiver 768, among other components. The mobile computing device 750 may also be provided with a storage device, such as a micro-drive or other device, to provide additional storage. Each of the processor 752, the memory 764, the display 754, the communication interface 766, and the transceiver 768, are interconnected using various buses, and several of the components may be mounted on a common motherboard or in other manners as appropriate.

The processor 752 can execute instructions within the mobile computing device 750, including instructions stored in the memory 764. The processor 752 may be implemented as a chipset of chips that include separate and multiple analog and digital processors. The processor 752 may provide, for example, for coordination of the other components of the mobile computing device 750, such as control of user interfaces, applications run by the mobile computing device 750, and wireless communication by the mobile computing device 750.

The processor 752 may communicate with a user through a control interface 758 and a display interface 756 coupled to the display 754. The display 754 may be, for example, a TFT (Thin-Film-Transistor Liquid Crystal Display) display or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may provide communication with the processor 752, so as to enable near area communication of the mobile computing device 750 with other devices. The external interface 762 may provide, for example, for wired communication in some implementations, or for wireless communication in other implementations, and multiple interfaces may also be used.

The memory 764 stores information within the mobile computing device 750. The memory 764 can be implemented as one or more of a computer-readable medium or media, a volatile memory unit or units, or a non-volatile memory unit or units. An expansion memory 774 may also be provided and connected to the mobile computing device 750 through an expansion interface 772, which may include, for example, a SIMM (Single In Line Memory Module) card interface. The expansion memory 774 may provide extra storage space for the mobile computing device 750, or may also store applications or other information for the mobile computing device 750. Specifically, the expansion memory 774 may include instructions to carry out or supplement the processes described above, and may include secure information also. Thus, for example, the expansion memory 774 may be provided as a security module for the mobile computing device 750, and may be programmed with instructions that permit secure use of the mobile computing device 750. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 752), perform one or more methods, such as those described above. The instructions can also be stored by one or more storage devices, such as one or more computer- or machine-readable mediums (for example, the memory 764, the expansion memory 774, or memory on the processor 752). In some implementations, the instructions can be received in a propagated signal, for example, over the transceiver 768 or the external interface 762.

The mobile computing device 750 may communicate wirelessly through the communication interface 766, which may include digital signal processing circuitry where necessary. The communication interface 766 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 768 using a radio-frequency. In addition, short-range communication may occur, such as using a Bluetooth®, Wi-Fi™, or other such transceiver (not shown). In addition, a GPS (Global Positioning System) receiver module 770 may provide additional navigation- and location-related wireless data to the mobile computing device 750, which may be used as appropriate by applications running on the mobile computing device 750.

The mobile computing device 750 may also communicate audibly using an audio codec 760, which may receive spoken information from a user and convert it to usable digital information. The audio codec 760 may likewise generate audible sound for a user, such as through a speaker, e.g., in a handset of the mobile computing device 750. Such sound may include sound from voice telephone calls, may include recorded sound (e.g., voice messages, music files, etc.) and may also include sound generated by applications operating on the mobile computing device 750.

The mobile computing device 750 may be implemented in a number of different forms, as shown in the figure. For example, it may be implemented as a cellular telephone 780. It may also be implemented as part of a smart-phone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a system and method for sharing assets between fleets are provided. Having described certain implementations of methods and apparatus for supporting fleet sharing, it will now become apparent to one of skill in the art that other implementations incorporating the concepts of the disclosure may be used. Therefore, the disclosure should not be limited to certain implementations, but rather should be limited only by the spirit and scope of the following claims.

Throughout the description, where apparatus and systems are described as having, including, or comprising specific components, or where processes and methods are described as having, including, or comprising specific steps, it is contemplated that, additionally, there are apparatus, and systems of the disclosed technology that consist essentially of, or consist of, the recited components, and that there are processes and methods according to the disclosed technology that consist essentially of, or consist of, the recited processing steps.

It should be understood that the order of steps or order for performing certain action is immaterial so long as the disclosed technology remains operable. Moreover, two or more steps or actions may be conducted simultaneously.

1. A method for sharing a fleet of shared assets among two or more entities, the method comprising:
receiving, by a processor of a computing device, from a control terminal associated with a shared asset, a request to physically access the shared asset, wherein the request includes an identifier;
following receipt of the request to physically access the shared asset, determining, by the processor, that the identifier substantially matches an identifier associated with a reservation of the shared asset for a predetermined time window, wherein a time of receipt of the request is within the time window, then sending, by the processor, over a network, a signal to the control terminal granting access to the shared asset; and
following determination that the identifier is valid, updating, by the processor, fleet data associated with the shared asset to change the fleet data from a first fleet associated with a first entity to a second fleet associated with a second entity.

2. The method of claim 1, comprising:
receiving, by the processor, from the control terminal, a request to return the shared asset; and
updating, by the processor, fleet data associated with the shared asset to change the fleet data from the second fleet to the first fleet.

3. The method of any of claims 1 to 2, wherein the request to physically access the shared asset is a request to unlock the shared asset.

4. The method of claim 3, wherein the request to physically access the shared asset is a request to unlock a door of the shared asset.

5. The method of any of claims 1 to 4, wherein the control terminal is configured to interact with a lock associated with the shared asset to allow physical access to the shared asset based on the signal.

6. The method of any of claims 1 to 5, wherein the shared asset is a shared vehicle.

7. The method of any of claims 1 to 6, wherein first entity is a rental vehicle entity and the second entity is a vehicle sharing entity.

8. The method of any of claims 1 to 7, comprising:
following determination that the identifier is valid, updating, by the processor, location data associated with the shared asset to change location data associated with the shared asset from a first location within the second fleet to a second location within the second fleet.

9-11. (canceled)

12. The method of any of claims 8 to 11, wherein the location data is used to track downtime and utilization.

13. The method of any of claims 8 to 12, comprising:
tracking, by the processor, changes to the location data associated with the shared asset.

14-16. (canceled)

17. The method of any of claims 1 to 16, comprising:
tracking, by the processor, changes to the fleet data associated with the shared asset.

18-20. (canceled)

21. The method of any of claims 1 to 20, comprising:
accounting, by the processor, for at least one of utilization, downtime, parking expenses, insurance costs, maintenance costs and depreciation based at least in part on an amount of time the shared asset is assigned to each of the first fleet and the second fleet.

22. A method for sharing a fleet of shared assets among two or more entities, the method comprising:
receiving, by a processor of a computing device, a request to move a plurality of shared assets between a first entity and a second entity by changing fleet data stored in a database and associated with each shared asset of the plurality of shared assets from a first fleet associated with the first entity to a second fleet associated with the second entity, thereby assigning each shared asset of the plurality of shared assets to the second fleet;
updating, by the processor, fleet data associated with the plurality of shared assets to change the fleet data from the first fleet to the second fleet; and
accounting, by the processor, for at least one of utilization, downtime, parking expenses, insurance costs, maintenance costs and depreciation based at least in part on an amount of time each asset in the plurality of shared assets is assigned to each of the first fleet and the second fleet.

23. The method of claim 22, comprising:
receiving, by the processor, a request to dispatch the plurality of shared assets from a first location within the second fleet to a second location within the second fleet; and
updating, by the processor, location data associated with each shared asset of the plurality of shared assets to change the location data from the first location (e.g., service location) within the second fleet to the second location (e.g., revenue location) within the second fleet.

24-28. (canceled)

29. The method of any one of claims 23 to 28, wherein the location data is used to track downtime and utilization.

30-31. (canceled)

32. The method of any of claims 23 to 31, comprising:
accounting, by the processor, for at least one of utilization, downtime, parking expenses, insurance costs, maintenance costs and depreciation based at least in part on an amount of time each asset in the plurality of shared assets is assigned to each of the first location and the second location.

33. The method of any of claims 22 to 32, wherein each asset of the plurality of shared assets is a shared vehicle.

34. The method of any of claims 22 to 33, wherein first entity is an asset sharing entity and the second entity is an asset rental entity.

35. The method of claim 34, wherein the asset sharing entity is a vehicle sharing entity and the shared asset rental entity is a vehicle rental entity.

36. The method of any of claims 22 to 35, comprising:
tracking, by the processor, changes to the fleet data for each asset of the plurality of shared assets.

37-78. (canceled)
